(19) United States
(12) Patent Application Publication
(10) Pub. No.: US 2026/0342911 A1
(43) Pub. Date: Oct. 29, 2026

(54) DETECTION SYSTEM FOR MISSING PERSONS

(71) Applicant: Vector Flight LLC, San Francisco, CA (US)

(72) Inventors: Eliot GILLUM, San Francisco, CA (US); Kevin Ho Wing LAU, San Jose, CA (US)

(73) Assignee: Vector Flight LLC, San Francisco, CA (US)

(21) Appl. No.: 19/703,508

(22) Filed: Jun. 10, 2026

Related U.S. Application Data
(63) Continuation of application No. PCT/US2024/059732, filed on Dec. 12, 2024.
(60) Provisional application No. 63/608,827, filed on Dec. 12, 2023.
(60) Provisional application No. 63/624,907, filed on Jan. 25, 2024.

(51) Int. Cl. H04M 3/42; G06Q 50/26

(52) U.S. Cl. CPC H04M 3/42357; G06Q 50/265; H04M 3/42382; H04M 2203/256; H04M 2242/04; H04M 2242/30

(57) ABSTRACT

A system and method for conducting a search for a search subject. The system and method includes receiving a request to initiate a search for a search subject having an associated mobile device, the mobile device having a mobile telephone number. A search record is created and associated with the mobile telephone number and the location information is forwarded to one or more search agencies. The method includes communicating with the search subject and obtaining search information for the search subject; and communicating the search to the one or more search agencies.

### CLAIM OF PRIORITY

This application claims priority to: PCT International Application No. PCT/US2024/059732, entitled “DETECTION SYSTEM FOR MISSING PERSONS”, filed Dec. 12, 2024; U.S. Provisional Patent Application No. 63/608,827, entitled “DETECTION SYSTEM FOR MISSING PERSONS”, filed Dec. 12, 2023; and U.S. Provisional Patent Application No. 63/624,907, entitled “DETECTION SYSTEM FOR MISSING PERSONS”, filed Jan. 25, 2024, all of which applications are incorporated by reference herein in their entirety.

### BACKGROUND

When people become lost, rescue workers and emergency responders are often tasked with searching an area of difficult terrain, and possibly unfamiliar surroundings. Often, people on foot or in search vehicles such as helicopters, airplanes, and off-road motor vehicles may be utilized to cover more search areas than would be possible by humans searching on foot. Applications have been developed to allow search subjects to provide their location using a mobile device using applications installed on the device.

### SUMMARY

The technology briefly described comprises a search system configured to locate a missing search subject using a mobile device, and to communicate with the search subject more efficiently. One general aspect includes a processor enabled method enabling a search service. The method also includes receiving a request to initiate a search for a search subject having an associated mobile device, the mobile device having a mobile telephone number; creating a search record associated with the mobile telephone number forwarding the location information to one or more search agencies, communicating with the search subject and obtaining search information for the search subject, and coordinating communications between the search subject and the one or more search agencies by communicating the search information to the one or more search agencies. Other embodiments of this aspect include corresponding computer systems, apparatus, and computer programs recorded on one or more computer storage devices, each configured to perform the actions of the methods.

Embodiments of the method may include the processor enabled method where the method further may include: providing a search application to the user of the mobile device; and receiving, via the application, profile information for the user including the mobile telephone number. Embodiments of the method may include any of the foregoing embodiments wherein the communicating may include receiving messages from the search subject and sending messages to the search subject requesting additional search information. Embodiments of the method may include any of the foregoing embodiments wherein the search application includes a user interface for the search subject to request a new search for the search subject. Embodiments of the method may include any of the foregoing embodiments wherein the request to initiate a search is received from the search subject via the user interface and the request includes location information associated with the mobile telephone number. Embodiments of the method may include any of the foregoing embodiments wherein the location information is associated with the mobile telephone number prior to any communications with the search subject regarding the search. Embodiments of the method may include any of the foregoing embodiments wherein the communicating may include providing a link in a short message service (SMS) message for responding with coordinates, receiving location information in an alternative location-based data interchange format via SMS, and presenting the location information to the searchers. Embodiments of the method may include any of the foregoing embodiments wherein the alternative format is a standard location-based data interchange format and the method processes the overall location information as if location information was not sent in the alternative location-based data interchange format. Embodiments of the method may include any of the foregoing embodiments wherein an image is received, and the image presented intact to the search agencies. Embodiments of the method may include any of the foregoing embodiments wherein the image is scanned for text via optical character recognition and, if location coordinate text is found, the coordinates are supplied to the search agencies. Implementations of the described techniques may include hardware, a method or process, or computer software on a computer-accessible medium.

Another aspect includes a non-transitory computer-readable medium storing computer instructions for enabling a search for a missing search subject. The non-transitory computer-readable medium storing computer instructions cause one or more processors to perform the steps of: receiving a request to initiate a search for the search subject having an associated mobile device, the mobile device having a mobile telephone number; creating a search record associated with the mobile telephone number, forwarding the location information to one or more search agencies, communicating with the search subject and obtaining search information for the search subject, and coordinating communications between the search subject and the one or more search agencies by communicating the search information to the one or more search agencies.

Embodiments of the computer readable medium of the computer readable medium may include any of the foregoing embodiments wherein the instructions cause the one or more processors to perform the steps of: providing a search application to the user of the mobile device; and receiving, via the application, profile information for the user including the mobile telephone number. Embodiments of the computer readable medium may include any of the foregoing embodiments wherein the communicating may include receiving messages from the search subject and sending messages to the search subject requesting additional search information. Embodiments of the computer readable medium may include any of the foregoing embodiments wherein the instructions cause the one or more processors cause to the search application to generate a user interface for the search subject to request a new search for the search subject. Embodiments of the computer readable medium may include any of the foregoing embodiments wherein instructions cause the processor to receive the request to initiate a search from the search subject via the user interface and the request includes location information associated with the mobile telephone number. Embodiments of the computer readable medium may include any of the foregoing embodiments wherein the instructions cause the one or more processors to associate the location information with the mobile telephone number prior to any communications with the search subject regarding the search. Embodiments of the computer readable medium may include any of the foregoing embodiments wherein the instructions cause the one or more processors to provide a link in an SMS message to the search subject, the link for responding with location coordinates, receive location information in an alternative location-based data interchange format via SMS, and present the location information to the search agencies. Embodiments of the computer readable medium may include any of the foregoing embodiments wherein the alternative format is a standard location based data interchange format and the method processes the overall location information as if location information was not sent in the alternative location-based data interchange format. Embodiments of the computer readable medium may include any of the foregoing embodiments wherein an image is received, and the instructions cause the one or more processors to provide the image intact to the search agencies. Embodiments of the computer readable medium may include any of the foregoing embodiments wherein the instructions cause the one or more processors to scan the image for text via optical character recognition and, if location coordinate text is found, the coordinates are supplied to the search agencies.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to embodiments that solve any or all disadvantages noted in the Background.

### BRIEF DESCRIPTION OF THE DRAWINGS

Aspects of the present disclosure are illustrated by way of example and are not limited by the accompanying figures for which like references indicate the same or similar elements.

FIG. 1 depicts an overview of a search system in which the technology may be used.

FIG. 2 is a flowchart illustrating one embodiment of the use of a search service to find a search subject.

FIG. 3 is a flowchart illustrating a method of performing a search for a search subject.

FIG. 4 illustrates a user interface which may be provided within the search application.

FIG. 5 is a flowchart illustrating a method performed by a search service to coordinate information amongst search agencies.

FIGS. 6 and 7 illustrate messages between a search service and a search subject in a conventional messaging interface.

FIG. 8 illustrates the process which occurs at the search service provider initiates a search.

FIG. 9A illustrates an example interface console of the search service provider.

FIG. 9B illustrates communication between the search service and search agencies.

FIG. 10 includes a depiction of an example of typical architecture for a mobile device.

FIG. 11 is a block diagram of a network processing device that can be used to implement various embodiments of the search service provider.

### WRITTEN DESCRIPTION

The technology described herein provides a search system allowing searchers to more reliably and efficiently search for people associated using their mobile device. The system and method for conducting can receive search requests for search subjects (missing individuals) and initiate a search for the search subject when the subject has an associated mobile device. Each mobile device having a mobile telephone number that can be used to track the search, and coordinate efforts of multiple search agencies. A search record is created and associated with the mobile telephone number and the location information is forwarded to search agencies. Embodiments disclosed herein allow for communication with the search subject using various channels and obtaining search information for the search subject, which can then be communicated the search to search agencies. In addition, the system facilitates sharing of search information between the various agencies.

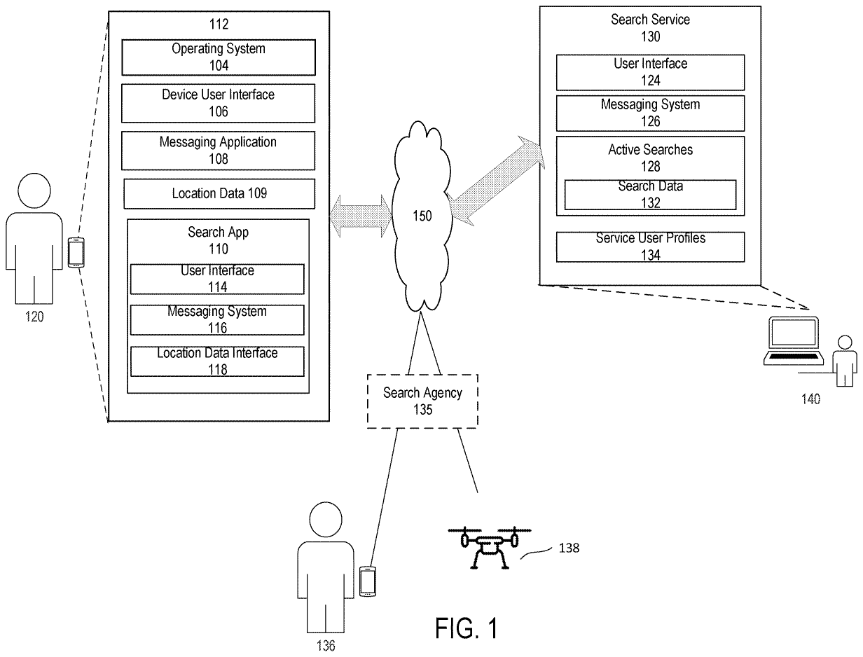

FIG. 1 illustrates an overview of a search system in accordance with the present technology. Shown in FIG. 1 is a human search subject 120 having an accompanying (associated) mobile device 112. The mobile device has connectivity to a network 150. The network 150 may be any form of public or private network including a cellular network, Wi-Fi network, or any combination of wired and wireless networks (such as the Internet) allowing the device to communicate with other mobile devices and other processing devices. Also shown in FIG. 1 is a search service 130, a search agency 135, a human searcher 136, and a search vehicle 138. In embodiments, there are generally multiple human searchers 136 and/or multiple search vehicles 138. In embodiments, there may be multiple search agencies 135 who provide the human searchers and search vehicles 138. Examples of search agencies 135 include search and rescue teams and emergency response teams such as mountain rescue teams, volunteer rescue teams, and the like, which generally have activities coordinated by a search agency authority. The human searcher 136 may work on foot, or on any type of vehicle, including but not limited to all-terrain motor vehicle, a manned aircraft and/or an unmanned aircraft, such as that illustrated at 138 (UAV). Searching may be performed in accordance with the teachings of U.S. Pat. No. 11,189,150, although the methods of searching by search agencies are not limited to these techniques.

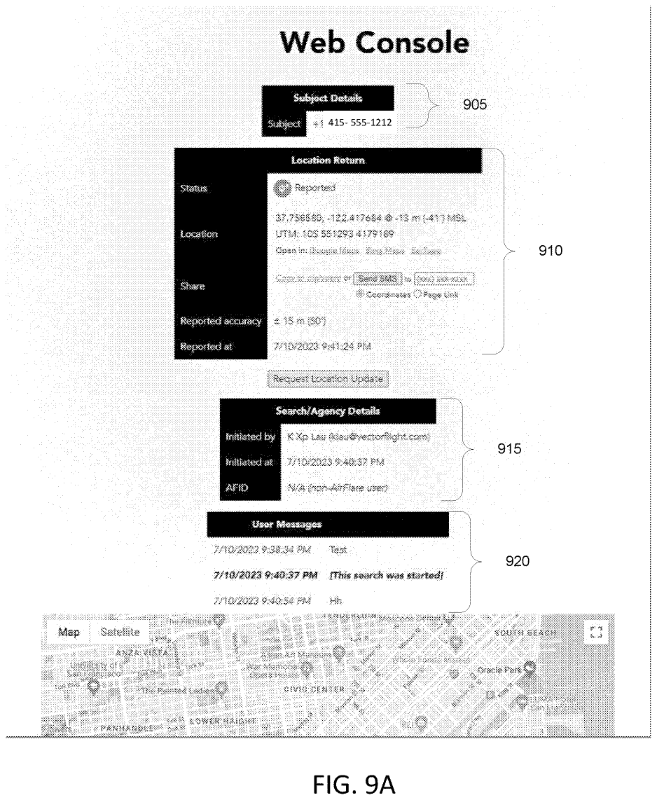

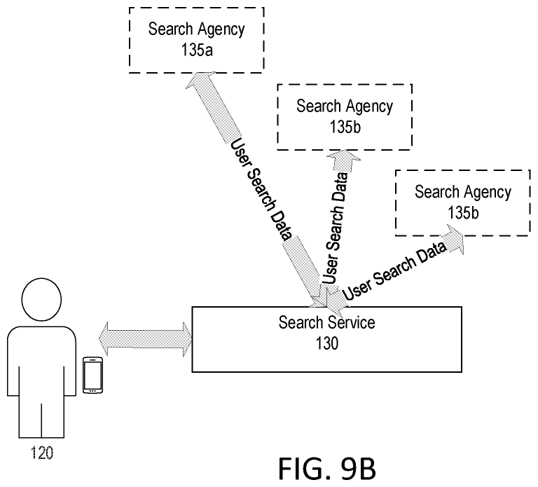

As illustrated in FIG. 1, a user's mobile device 112 will typically include an operating system 104, a device user interface 106, and a native or default messaging application 108. (Additional details of a mobile device are illustrated in FIG. 9.) The default messaging application 108 may be any of various types of messaging applications utilized on mobile phones including SMS/MMS Apps pre-installed on devices which support basic SMS (Short Message Service) and MMS (Multimedia Messaging Service) and Internet-based messaging applications that support additional features (such as Apple Corporation's iMessage service). Mobile device 112 may also have location data 109 which is derived from positioning technologies such as the global positioning system (GPS) or other location positioning technologies.

Also shown on device 112 is a search application 110. The search application may be similar to application described in U.S. Pat. No. 11,189,150 and may include a user interface 114, and a location data interface 118. In contrast to the application described in U.S. Pat. No. 11,189,150, search application 110 includes a separate messaging system 116 which may be used as described below to provide additional information to the operators 140 of a search service 130.

In embodiments, the search application 110 is provided and administered by the search service 130, and integrates with services provided by the search service 130. As illustrated in FIG. 1, search service 130 may be operated on any one or more processing devices by a search service operator 140. The search service 130 may include a user interface 124, a messaging system 126, service user profiles 134, a database of active searches 128 and search data 132 on the active searches. The search data may include, for each search, identifying information on the subject of the search, including at least the subject's mobile number and name. For searches where the subject has the search application 110 installed, the search data 132 may include information from a user's search application. Messaging system 126 may communicate with the messaging application 108 on device 112 and, if search application 110 is installed, the messaging system 116 of the search application 110.

In some searches, the search service 130 coordinates searches for search agencies 135 for users having a mobile device 112 of the search subject where no search application 110 is installed on the device 112. In cases where the search application 110 is installed, the search service 130 may interact with the search application 110 when a user, such as user 120, is in need of assistance. In embodiments, the search application 110 can automatically, or at the direction of user 120, notify the search service 130 that the user 120 is in need of assistance and initiate a search for the user at the direction of the service operator 140. The initiation of a search may include providing information that can assist search agencies 135 in locating a missing user. The service operator 140 can, through the search service 130, communicate with agencies 135, searchers 136 and search vehicles 138, as well as obtain location data 109 from the application 110/device 112 in order to locate the search subject 120. The search service 130 is also useful in situations where the search subject's mobile device 112 does not include search application 110, and does not automatically obtain location data 109. In cases where the application 110 is not installed, the native messaging application 108 can be used to provide location data 109 for the mobile device 112. In both cases, when a search is initiated for a user, the search service 130 associates at least a user phone number with an active search and records this association in the search data 132 for active searches. If the user phone number is present in service user profile 134, additional information such as the user's name may be available.

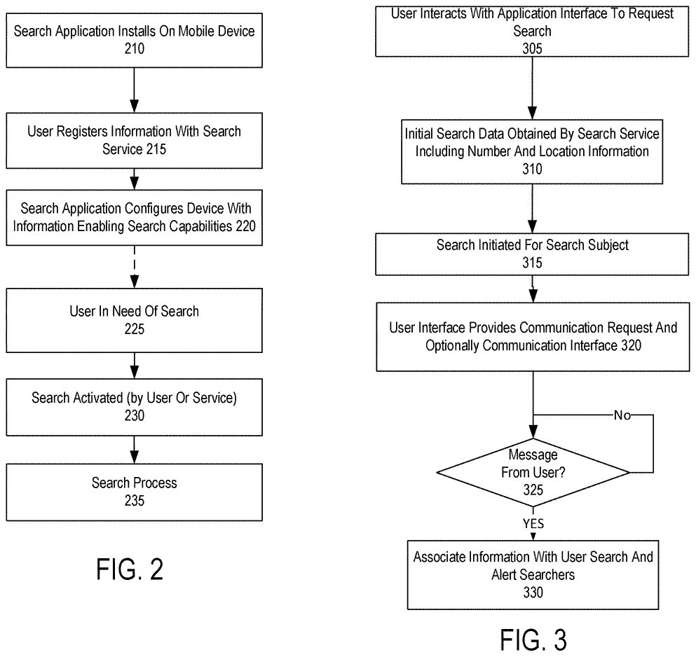

FIG. 2 is a flowchart illustrating one embodiment of the use of a search service 130 to find a search subject 120. At 210, the user of a mobile device will install a search application 110 on the mobile device. At 215, the user will input profile information into the search application. This information typically includes a user identifier, such as the mobile device number for the user's device, the users name, and the user's approximate age. At 220, search application 110 configures the mobile device with information enabling search capabilities. (These may include an interface to the device's positioning technology which enables the application 110 to extract and send location information when a search is started.)

At a later point in time (as indicated by the dashed line between steps 220 and 225,) when the subject 120 is in need of a search at 225, the search can be activated at 230 by the search service 130, by the user using the search application 110 or by the user 120 through a manual process (without using the search application) such as making a phone call or sending an message thorough the native messaging application 108. At 235, the search process begins in any number of ways. In one embodiment, the search application 130 can provide location data to the search service 130 and the search service 130 can direct searchers to the subject's location. In other embodiments, such as those described in above U.S. Pat. No. 11,189,150, a search device carried by a searcher 136 or a search vehicle 138 can be deployed to seek out the user in need of assistance, and return location information to the search service provider.

As noted above, the search service 130 can also be utilized in conjunction with components of the mobile device which are installed on the device, and without the use of the search application.

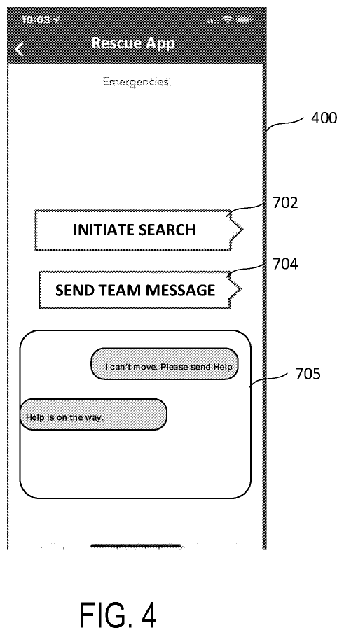

FIG. 3 is a flowchart illustrating a method performed by a user and the search service in initiating and conducting a search for the user. At 305, a user may interact with the user interface of search application 110 to initiate a search. One example of a search application interface is shown in FIG. 4 illustrates an interface which may be provided within the search application itself. As illustrated therein, the interface includes an initiate search button 402 and a send team message button 404 allow the user to input messages directly into a message interface window 705 within the application 110 itself. This simplifies transmission of messages to the search team via the search service. Alternatively, the user may send and receive messages via the native messaging application 108.

At 310, search data is obtained by the search service from the application 110. In embodiments, location information can be extracted by the search application 110 and provided to the search service 130. The search data may be associated with the user's phone number and user profile. The search service 130 now has a record of the location of the user before any other communication with the user has occurred. This pre-call/pre-message interaction allows the search service 130 to begin coordinating search agencies without additional communication to the user. The search service 130 coordinates search activities using the location information provided by the search application and may engage in further communication with the user. At 315, the search service 130 may initiate a new search for the user by contacting one or more search agencies to begin search operations. Optionally, at 320, the user interface of application 110 may display a request for additional information from the user at 310. The communication request may be generated automatically by the application 110 or initiated by the search service 130 If additional messages (or calls) are received at 325, the information from the user can be associated with the user search and distributed to one or more search agencies at 330.

In contrast to the application provided in U.S. Pat. No. 11,189,150, the search application user interface 400 can provide a messaging interface at 705 to communicate with the messaging system 116 of the search application 110. This messaging interface can be used to directly provide messages between the search service 130 and the search subject 120. The messages can appear in a user interface as illustrated in FIG. 4, and on a control console for the search service as illustrated in FIG. 9A.

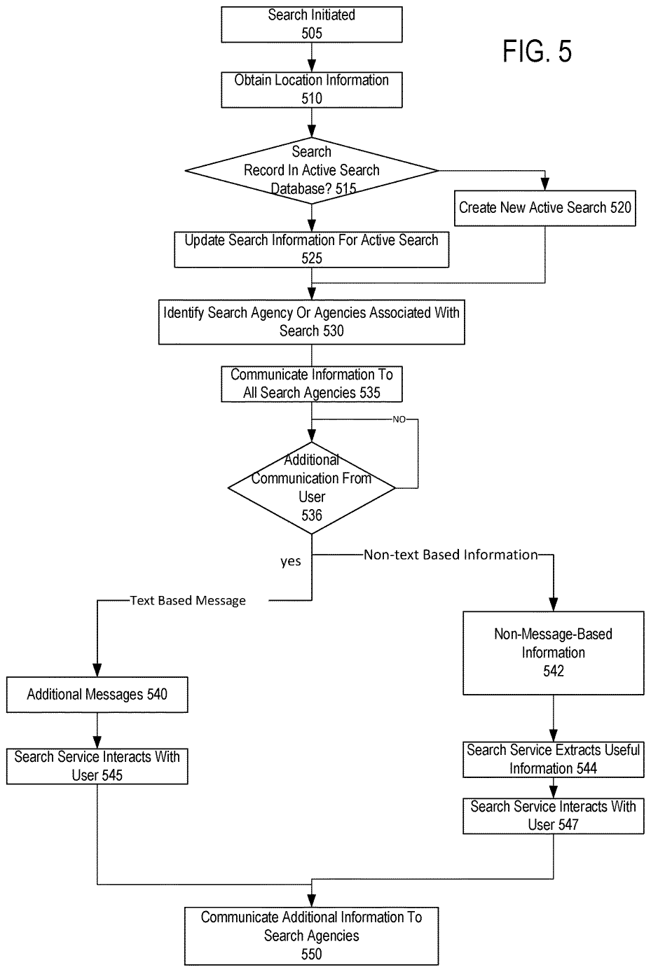

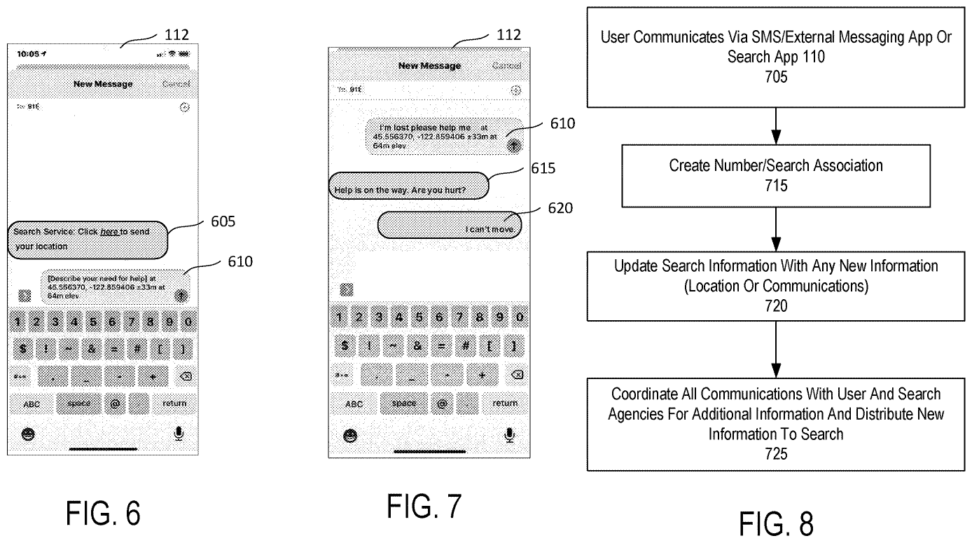

If the application 110 is not installed at 310, then a location request message can be sent at 315 using the internal messaging application of the mobile device. This may take the format illustrated in FIG. 5. If the user responds to a location request at 320, this information is passed on to the searchers at 335. In addition, the user can reply to the message at 325 using the device user interface 106 and default messaging application 108 interface, illustrated in FIGS. 5 and 6, below. If other messages are received from the user at 330, the information is associated with the user search and searchers are alerted at 335.

Optionally, in embodiments, after step 315, a timeout may occur-a threshold time period may begin running after which additional messages from the user are not accepted. This allows “timing out” searches by the search service 130 where the user no longer needs to be located but at times when the user has not reported an end to the search to the search service.

In an alternative, searches may be initiated by the user without interacting with the application 110. For example, a user may reach out to a search agency or a search service via a messaging application 108 or may have a message sent to them by one of the services or agencies. A user may then receive a location request message, and the user may reply via the device messaging application 108 or by selecting a hyperlink in the location request message.

FIG. 5 is a flowchart illustrating a second method of conducting a search for a user. At 505 a search is initiated for a user via the search application 110 (by the user), by one of the search agencies, or by a communication from the user not using the search application 110. In embodiments, the pre-call/pre-message initiation described above is advantageous in that location and identification information is provided as quickly as possible (before other communication), thereby allowing initiation of the search and location of the search to be more rapidly started. At 510 initial search location information is obtained by the search service 130, along with any information identifying the user, such as the user's phone number. At 515, a determination is made by the search service as to whether there is an active search for the user already in progress and for which a record in the data of active searches 128 exists. If not, a new active search record is created at 520. Optimally with the identifying information and the initial location. If so, any new information obtained by the search service is updated at 525. At 530 any and all search agencies involved in the search for the user are identified and any new information provided at 510 or available in the search record are communicated to the search agencies participating in the search at 535. If additional communications from the user are received at 536, a determination is made as to whether the communication is a text based message or other types of information from the user's phone. In embodiments, step 540 comprises receiving text-based messages as described herein from the user via a messaging application on the phone, a specialized messaging application in the rescue application, or other mechanisms.

If additional messages from the user are received at 540, the search service 130 may interact directly with the user at 545 and communicate additional information to the search agencies at 550.

In embodiments, because of the familiarity of the SMS medium and toolset, for various reasons, search subjects may respond with other than the intended action of using the link to provide their coordinates to the searchers. When this occurs, non-message based information may be received at 542. For various reasons, a user may be unable to access the URL, for lack of bandwidth or other reasons, not have read the directions, misunderstood the searcher or search system, or decided their action was superior. Whatever the reason, the user at 542 may respond with pictures, which could be of an injury, the area around them to illustrate their location or potential issue in accessing it, or even a screenshot of a mapping application. Alternatively, or in addition to text messages, the user may use capabilities built into the SMS application, operating system, or a 3rd party application that provides location information or other information that is useful to the search agency. In all cases, the information should be presented to the searcher, and interpreted if possible. The ability to understand unexpected location formats allows the resumption of the full search process without additional effort or training on the part of the searcher. Hence, at 544 the search service may extract useful information from the application based (or non-text based) information provided by the user. In cases where the information is provided through an application which allows further communication with the user, at 547 the search service may interact with the user. Both types of information may be provided to the search agencies at 550.

The additional communication from the user may be the result of having provided a link in SMS message to the user for responding with to the search service with location coordinates, and receiving alternative non-text information or formats via SMS. This information can then be interpreted and adapted by the agency at 544 a surrogate to the requested original request, and presenting those to the searcher agencies. In embodiments, the alternative format is a standard location-based data interchange format, or otherwise recognizable coordinate format, examples of which include Apple vCard, Apple Maps URL, Google Maps URL. These location-based data interchange formats facilitate the sharing and use of location-based information and is designed for use within its respective ecosystem (Apple or Google) but can be adapted or converted for cross-platform sharing. At 544, the search service processes the overall Location Request as if the user had used the original link to send coordinates in the expected manner. In embodiments, at 544, an image is received, and after extraction, is presented intact to the search agencies. In embodiments, the image is scanned for text via OCR and, if coordinate-like text is found, the coordinates are processed and forwarded as if supplied via the original link mechanism. In embodiments, the interpretation of an image at 544 may be performed by a human actor at the search service or programmatically and automatically by instructions enabling one or more processors to extract the information.

Optionally, in embodiments, after step 520, the above-described timeout of a search may occur as described above.

FIGS. 6 and 7 illustrates a conventional messaging interface and the type of message a user may send to initiate a search using a conventional messaging service. As illustrated in FIG. 6, the search service 130 may send a message 505 to the user indicating that the user can select a hyperlink to send the user's location information to the search service (as described above). Once the user selects the hyperlink and message 605, an auto generated message is created at 610 which prompts the user to describe the need for help and also provides the user's location coordinates. FIG. 7 illustrates additional messages 615 and 620 which are communicated back and forth between the user and the search service in accordance with step 540 above.

FIG. 8 illustrates a process for creating a new active search in step 520 of FIG. 5 when a user communicates with the search service 130 as the coordinator or one or more searches for a user. When a user communicates with the search provider 130 via a native messaging application on the mobile device, or via the search application 110a, a user/phone number association is created in the active search data 132 at 715. At 705, a determination is made by the search service 130 as to whether not the mobile number identified in the inbound message to the provider is associated with an active user search. If no association is present, then a record is created associating the mobile number with a search record. The user/phone number association may include the user profile information and any location information which is the result of the user pre-call/pre-message information transfer or provided by the user using the native messaging service or the hyperlink in the message as in FIG. 6. Any new information (location information or communications from the user subsequent to the information request) are updated to the search data 321 at step 720 and distributed by the search services at 725. If the mobile number is present in the search database, then search information is updated and provided to searchers as discussed above at 720. At 720, optionally, the search service may continue to communicate with the user for additional information, such as whether or not the user is injured or needs additional assistance, and continually provide this information to search agents.

FIG. 9A illustrates an example interface console presented to the search service operator 140. The interface includes details for the search subject at 905, such as the user's mobile device, location information and status at block 910, information on the search agency which initiated the search at 915, and user messages at 920. At 905, the user identification is associated with the user's phone number. Location information 910 includes options to share the information via an SMS message to various agencies or individuals. The search agency details 915 illustrates only one search agency for this active search, but multiple agencies may be displayed, and notes that the search subject is not a user of the search application 110. The user messages 920 displays any messages which are sent by the user to the search service 130 via the application 110 or the native messaging application on the user's mobile device. As illustrated in FIG. 9B, each of multiple search agencies 135a, 135b, and 135c are in communication with the search service 130. The search service 130 is in communication with the search subject 120 and serves as a central coordinator for all agencies who are seeking the search subject.

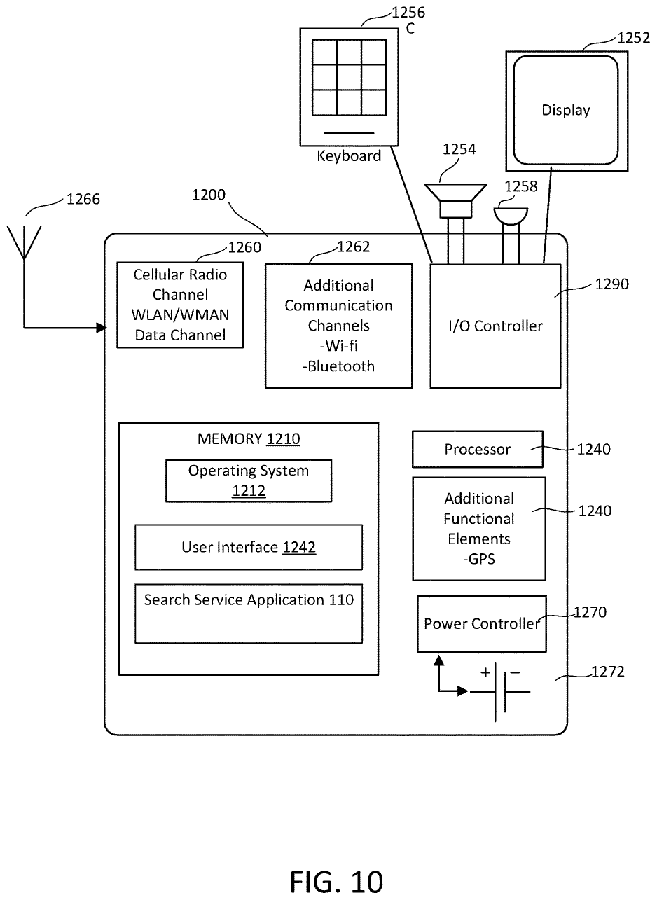

FIG. 10 includes a depiction of an example of typical architecture for a mobile device. The mobile device 1200 has memory 1210, processor 1240, an input/output (I/O) controller 1290, a cellular radio channel and WLAN/WMAN data channel 1260, and power controller 1270. Each of these components may connected through a system bus (not shown).

Memory 1210 includes the mobile device's operating system 1212, and one or more applications, including search application 110 and comprises volatile and non-volatile storage. The operating system 1212 handles the different operations of the mobile device 1200 and may contain user interfaces for operations, such as placing and receiving device calls, text messaging, checking voicemail, and the like.

The operating system 1212 manages the hardware of the mobile device 1200, including hardware such as the display 1252, speaker 1254, keyboard 1256, and camera 1258. The operating system 1212 also manages software (i.e. applications) on the mobile device 1200 for performing tasks requested by the user and handling incoming data, for example. The power controller 1270 of the mobile device 1200 allocates power from the mobile device's power supply 1272 to the circuitry for different mobile device components used to operate the mobile device 1200 and its different features.

The mobile device 1200 also contains a cellular radio channel and WLAN/WMAN data channel 1260 for receiving and transmitting data, such as device calls, text messages, email, webpage data, and the like. Cellular radio communication can occur through any of the standard network protocols of mobile device communication (i.e. GSM, PCS, D-AMPS, UMTS, and the like.). The mobile device 1200 may also contain additional communication channels 1262, such as Wi-ﬁ, Bluetooth, and the like, for receiving and transmitting data as well. The mobile device 1200 may have additional functional elements for communication 1264, such as GPS. Each of the described communication mediums is accessed via the antenna 1266 on the mobile device 1200. The communication mediums for operations of the mobile device 1200 are not limited to the mediums described and can include any other communication mediums known in the art.

Searchers 136 may likewise be provided with a control device, which may be a mobile device such as that illustrated in FIG. 10 which may include an application allowing users to analyze and visualize search data or invoke such functionality from other applications on the device, in accordance with the discussion herein.

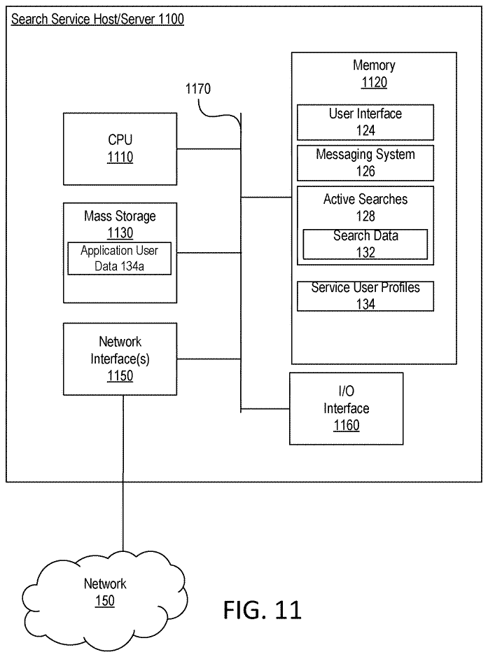

FIG. 11 is a block diagram of a network processing device that can be used to implement various embodiments of the search service provider. Specific network devices may utilize all of the components shown, or only a subset of the components, and levels of integration may vary from device to device. Furthermore, network device 1100 may contain multiple instances of a component, such as multiple processing units, processors, memories, transmitters, receivers, etc. The network device 1100 may comprise a processing unit 1110 equipped with one or more input/output devices, such as network interfaces, storage interfaces, and the like. The processing device may include processing unit 1110 comprising a central processing unit (CPU), a memory 1120, a mass storage device 1130, and an I/O interface 1160 connected to a bus 1170. The bus 1170 may be one or more of any type of several bus architectures including a memory bus or memory controller, a peripheral bus, or the like. A network interface 1150 enables the network processing device to communicate over a network 150 (described above) with other processing devices such as those described herein. The I/O interface is illustrated as connected to a display device (not shown).

The processing unit 1110 may comprise any type of electronic data processor. Memory 1120 may comprise any type of system memory such as static random-access memory (SRAM), dynamic random-access memory (DRAM), synchronous DRAM (SDRAM), read-only memory (ROM), a combination thereof, or the like. In an embodiment, memory 1120 may include ROM for use at boot-up, and DRAM for program and data storage for use while executing programs. In embodiments, the memory 1120 is non-transitory. In one embodiment, the memory 1120 includes computer readable instructions that are executed by the processor unit(s) 1110 to implement embodiments of the disclosed technology, including the meeting or real-time virtual environment application 1125a which may itself include a rendering engine 1125b, and converter 1175. The functions of the meeting application 1125a as operable on a client processing device are described herein in various flowcharts and Figures.

The mass storage device 1130 may comprise any type of storage device configured to store data, programs, and other information and to make the data, programs, and other information accessible via the bus 1170. The mass storage device 1130 may comprise, for example, one or more of a solid-state drive, hard disk drive, a magnetic disk drive, an optical disk drive, or the like. An instance of application user data 134a (derived from profiles 134) may be stored on the mass storage device 1130 in embodiments of the technology. The mass storage device 1130 may also include code comprising instructions for causing the CPU to implement the components search service described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, the system described could be used to locate a wide variety of targets and in various scenarios, like first responders while they're also looking for the missing victim, fire fighters in brush fires, police serving warrants, wandering elderly, lost children, horses, or dogs.

What is claimed is:

1. A processor enabled method enabling a search service, comprising:
receiving a request to initiate a search for a search subject having an associated mobile device, the mobile device having a mobile telephone number;
creating a search record associated with the mobile telephone number, the search record including location information;
forwarding the location information to one or more search agencies;
communicating with the search subject and obtaining search information for the search subject; and
coordinating communications between the search subject and the one or more search agencies by communicating the search information to the one or more search agencies.

2. The processor enabled method of claim 1 wherein the method further comprises:
providing a search application to the mobile device; and
receiving, via the application, profile information for a user including the mobile telephone number.

3. The processor enabled method of claim 2 wherein the communicating comprises receiving messages from the search subject and sending messages to the search subject requesting additional search information.

4. The processor enabled method of claim 2 wherein the search application includes a user interface for the search subject to request a new search for the search subject.

5. The processor enabled method of claim 4 wherein the request to initiate a search is received from the search subject via the user interface and the request includes location information associated with the mobile telephone number.

6. The processor enabled method of claim 5 wherein the location information is associated with the mobile telephone number prior to any communications with the search subject regarding the search.

7. The processor enabled method of claim 1 wherein the communicating comprises providing a link in a short message service (SMS) message for responding with coordinates, receiving location information in an alternative location-based data interchange format via SMS, and presenting the location information to the one or more search agencies.

8. The processor enabled method of claim 7 wherein the alternative format is a standard location-based data interchange format and the method processes the location information as if location information was not sent in the alternative location-based data interchange format.

9. The processor enabled method of claim 7 wherein an image is received, and the image presented intact to the search agencies.

10. The processor enabled method of claim 9 wherein the image is scanned for text via optical character recognition and, if location coordinate text is found, the coordinates are supplied to the search agencies.

11. A non-transitory computer-readable medium storing computer instructions for enabling a search for a search subject who is missing, that when executed by one or more processors, cause one or more processors to perform the steps of:
receiving a request to initiate a search for the search subject having an associated mobile device, the mobile device having a mobile telephone number;
creating a search record associated with the mobile telephone number, the search record including location information;
forwarding the location information to one or more search agencies;
communicating with the search subject and obtaining search information for the search subject; and
coordinating communications between the search subject and the one or more search agencies by communicating the search information to the one or more search agencies.

12. The non-transitory computer-readable medium storing computer instructions of claim 11 wherein the instructions cause the one or more processors to perform the steps of:
providing a search application to the mobile device; and
receiving, via the application, profile information for a user including the mobile telephone number.

13. The non-transitory computer-readable medium storing computer instructions of claim 12 wherein the communicating comprises receiving messages from the search subject and sending messages to the search subject, the sending messages requesting additional search information.

14. The non-transitory computer-readable medium storing computer instructions of claim 12 wherein the instructions cause the one or more processors cause to the search application to generate a user interface for the search subject to request a new search for the search subject.

15. The non-transitory computer-readable medium storing computer instructions of claim 14 the instructions cause the one or more processors to wherein receive the request to initiate a search from the search subject via the user interface and the request includes location information associated with the mobile telephone number.

16. The non-transitory computer-readable medium storing computer instructions of claim 15 wherein the instructions cause the one or more processors to associate the location information with a mobile telephone number prior to any communications with the search subject regarding the search.

17. The non-transitory computer-readable medium storing computer instructions of claim 16 wherein the instructions cause the one or more processors to provide a link in an SMS message to the search subject, the link for responding with location coordinates, receive location information in an alternative location-based data interchange format via SMS, and present the location information to the search agencies.

18. The non-transitory computer-readable medium storing computer instructions of claim 17 wherein the alternative format is a standard location based data interchange format and the instructions processes the location information as if location information was not sent in the alternative location-based data interchange format.

19. The non-transitory computer-readable medium storing computer instructions of claim 17 wherein an image is received, and the instructions cause the one or more processors to provide the image intact to the search agencies.

20. The non-transitory computer-readable medium storing computer instructions of enabled method of claim 19 where the instructions cause the one or more processors to scan the image for text via optical character recognition and, if location coordinate text is found, the coordinates are supplied to the search agencies.
